(19) United States
(12) Patent Application Publication
(10) Pub. No.: US 2007/0173399 A1
(43) Pub. Date: Jul. 26, 2007

(54) Process for obtaining zeolites more resistant to hydrothermal deactivation

(75) Inventors: Lam Yiu Lau, Rio de Janeiro (BR); Marlon Brando Bezerra De Almeida, Rio de Janeiro (BR); Alexandre De Figueiredo Costa, Rio de Janeiro (BR); Eliane Bernadete Castro Mattos, Rio de Janeiro (BR); Avelino Corma Canos, Valence (ES); Maria Margaret Ludvig, Seabrook, TX (US)

Correspondence Address: NIXON & VANDERHYE, PC, 901 NORTH GLEBE ROAD, 11TH FLOOR, ARLINGTON, VA, 22203, US

(73) Assignee: PETROLEO BRASILEIRO S.A. - PETROBRAS, Rio de Janeiro (BR)

(21) Appl. No.: 11/606,358

(22) Filed: Nov. 30, 2006

(30) Foreign Application Priority Data
Dec. 1, 2005 (BR) PI 0505365-0

(51) Int. Cl. B01J 29/04; B01J 29/00; C01B 39/00

(52) U.S. Cl. 502/60; 423/700; 502/77

(57) ABSTRACT

The present invention describes a process to obtain zeolites more resistant to calcination in the presence of water vapor at high temperatures, which is a characteristic condition found during the catalyst regeneration in the Fluid Catalytic Cracking (FCC). One apply the invention to high silica-alumina ratio (SAR) zeolites, for instance the ZSM-5 zeolite, which are able to crack only short hydrocarbon molecules, with normal or slightly branched carbon chain, and which are also able to increase considerably the yields of olefins and LPG. Through the combination of mild pre-calcination and phosphorous deposition one obtain a zeolite which presents higher catalytic activity than zeolites non treated or treated through other processes of the state-of-technique.

### BACKGROUND OF THE INVENTION

1. Field of the Invention

This invention is concerned with a process for the preparation of high silica-alumina ratio zeolites, which not only perform high activity in the hydrocarbons Fluid Catalytic Cracking (FCC) process but also are more resistant than zeolites obtained by other processes, to the deactivation that water vapor brings about at high temperatures.

2. Description of the Prior Art

From 1964, Y type zeolites became commercially available for FCC applications. In the next year, R. J. Argauer and G. R. Landolt synthesized for the first time ZSM-5 (Zeolite Socony Mobil #5) or MFI (Mobil Five) type zeolite, direct consequence of research carried out in the laboratories of Mobil Oil Corporation (U.S. Pat. No. 3,702,886). Rapidly, one determined its selectivity to gasoleum cracking, that is, one cracks only hydrocarbons which contain normal or slightly branched chains. However, in the following years one focused most of researching to the improvement of the stability and effectiveness of the until then novel Y type zeolite catalysts. Only at the end of the 70's the research begun to concentrate efforts on the ZSM-5 evaluation aiming at FCC applications. The first studies showed its structure nature and high silicon content confer it high thermal and hydrothermal stability. Mild hydrothermal treatment allows its use to octane improvement of gasoline produced by FCC.

Nowadays, one employs successfully zeolites with silica-alumina ratio (SAR) higher than 10, as active components added to the FCC catalysts, in order to increase the yields of high value-added products, for instance light olefins (propene and isobutene) and LPG. In the literature related to this subject, one find several studies about the performance of ZSM-5 zeolite in the following issues: “F. Degnan, G. K. Chitnis and P. H. Schipper, Hystory of ZSM-5 fluid cracking additive development at Mobil, Microporous and Mesoporous Materials, 35-36 (2000) 245-252”; “S. P. Donnelly, S. Mizzahi, P. T. Sparrel, A. Huss, Jr., P. H. Schipper and J. A. Herbst, How ZSM-5 works in FCC, Division of Petroleum Chemistry, ACS Meeting, August 30-September 4, New Orleans, 1987”; “A. S. Kishna, C. R. Hsieh, A. R. English, T. A. Picoraro and C. W. Kuehler, Additives improve FCC process, Hydrocarbon Processing, November (1991) 59-66”.

The works which teach methods to improve the performance or the hydrothermal stability of ZSM-5 became outstanding in the literature. The U.S. Pat. No. 3,972,832, the U.S. Pat. No. 4,456,780 and the European publication EP 1116775 teach the zeolite treatment with phosphorous compounds. Besides, the U.S. Pat. No. 4,544,793 and the publication of K. Fujisawa and co-workers, The steam stability of H-ZSM-5 type zeolites containing alkaline earth metals, Bull. Chem. Soc. Japan, 60 (1987) 791-793, teach the zeolite treatment with metals. Aiming to petrochemical reactions application, the U.S. Pat. No. 4,356,338 claims the lifetime extension of catalysts which contain ZSM-5 pre-calcined within a conditions range excessively large, between 250° C. and 1000° C., with 5% to 100% of water vapor and, optionally, with deposition of phosphorous compounds.

The literature depicts widely the ultra-stabilization of low SAR zeolites, especially those with Faujasite structure, very often referred as Y or X zeolites (SAR<7). The USY, the so-called product is well known by the area experts. The ultra-stabilization process, as it is usually practiced, employs high contents of water vapor (above 50%) and temperatures above 500° C. (typically 600° C. or higher), as described by C. V. McDaniel and P. K. Maher “Zeolite Chemistry and Catalysis, ACS Monograph 117, edited by J. A. Rabo and J. Scherzer in J. Catal., 54 (1978) 285-288”.

The effect of the water vapor treatment over high SAR (>10) zeolites has been approached toward a different point of view. The vanguard work of Haag and co-workers (U.S. Pat. No. 4,418,235) clearly shows the ZSM-5 zeolite activity increases pretty much (several times higher than the started activity) by a mild calcination, between 450° C. and 550° C., water vapor pressure in the range between 5% and 10% of atmospheric pressure (see also Lago and co-workers in Proced. 7th International Zeolite Conference). Such conditions are much more restricted than the conditions cited in the U.S. Pat. No. 4,356,338 mentioned previously.

The mild calcination effect was confirmed by several works published in the literature: “Y. Sendoda and Y. Ono, Effect of the pretreatment temperature on the catalytic activity of ZSM-5 zeolites, Zeolites, 8 (1988) 101”; “H. Kitagawa, Y. Sendoda and Y. Ono, Transformation of propane into aromatic hydrocarbons over ZSM-5 zeolites, J. Catal., 101 (1986) 12”; “T. Masuda, Y. Fujikata, S. Mukai and K. Hashimoto, Changes in Catalytic activity of MFI-type zeolites caused by dealumination in a steam atmosphere, Applied Catal., A., 172 (1998) 73-83”; “E. Brunner, et al., Solid-state NMR and catalytic studies of mildly hydrothermally dealuminated HZSM-5, Zeolites, 9 (1989) 282”. However, no publication of the open literature mentions the obtention of ZSM-5 zeolite more stable, upon the hydrothermal deactivation, through the combination between pre-calcination and phosphorous deposition, object of the present invention.

One knows the crystalline structure of USY and ZSM-5 type zeolites do not undergo considerable modification after water vapor deactivation. The micropores volume is preserved and the crystalline phase content does not change, as can be measured by X-ray diffraction (XRD). However, the amount of active sites, usually referred as acidic sites, drops after the treatment. One estimates the number of acidic sites by the adsorption analysis of basic molecules like ammonia, pyridine or organic amines. A general description of such methods can be found in textbooks, as in chapter 2 of “Zeolitos, um nanomundo ao serviçco da catálise”, by M. Guisnet and F. R. Ribeiro, published by Fundação Calouste Gulbenkian in 2004, ISBN 972-31-1071-7, Brazil.

The zeolite vapor pre-calcination followed by phosphorous deposition, taught in the U.S. Pat. No. 4,356,338, aims at the maintenance of the zeolite catalytic activity. The mild calcination taught by Haag and co-workers aims the zeolite activity increase, just after treating, for hydrocarbon reactions but not for the stabilization of active sites. One must point out, a plenty large examples of the literature demonstrated one does not achieve increase of catalytic activity whether the zeolite pre-treatment conditions are outside the range of either low temperature or water partial pressure or short calcination time, among them “T. Sano, et al., Dealumination of ZSM-5 zeolites with water, Chemistry Letter, 1421 (1987) 1424”, K. Zhang, et al., Selective dealumination of ZSM-5 by hydrothermal treatment, Chinese Chemical Letters, 9 (1998) 397”and “G. Debras, et al., Physical-chemical caracterization of pentasil type materials, IV. Thermal and steam stability, dealumination and aluminum exchange, Zeolites, 6 (1986) 241”.

One method pretty practical to determine the amount of acidic sites in a zeolite was developed by Gorte and co-workers. By using Temperature Programmed Dessorption (TPD) of n-propylamine, the number of amine molecules transformed in ammonia and propene molecules gives one measurement of the number of acidic sites, of the type Brönsted site, in the analyzed sample. This method did spread and it was issued in the publications “A. I. Biaglow, D. J. Parrilo, G. T. Kokotailo, R. J. Gorte, A study of dealuminated Faujasites, J. Catal., 148 (1994) 213-223”, “A. I. Biaglow, C. Gittleman, R. J. Gorte, R. J. Madon, 2-propanamine adsorption on a fluid catalytic cracking catalyst, J. Catal., 129 (1991) 88-93”and “0. Kresenawahjuesa, R. J. Gorte, D. de Oliveira, Y. L. Lam, A simple, inexpensive and reliable method for measuring Brönsted-acid site densities in solid acids, Catalysis Letters, 82 (2002) 155-160”.

Another method to determine the number of acidic sites, referred as “alpha test”, was developed by researchers of the Mobil Oil Corporation and spread in the publications “P. B. Weisz, J. N. Miale, J. Catal., 4 (1965) 527”, “D. H. Olsen, W. O. Haag, R. M. Lago, Chemical and physical properties of the ZSM-5 substitutional series, J. Catal., 61 (1980) 390”and “W. O. Haag, Catalysis by Zeolites—Science and Technology, Stud. Surf. Sci. Catal., 84 (1994) 1375”. One carry out the measurement of the amount of acidic through the reaction rate of modeling compounds, in particular, the n-hexane cracking. Nowadays, this method is widely applied by the area experts. Generally, one obtains linear correlations between the results of acidity measurements, via adsorption or via organic bases decomposition, and the results of catalytic tests.

The cracking of hydrocarbons occurs in the zeolite acidic sites, which is the active component of the FCC catalysts. The higher the amount of acidic sites, the higher the catalytic activity. With regard to the cracking of light hydrocarbons, the activity of FCC catalysts prepared with more acidic high SAR zeolites, as the zeolites pre-treated according to the process of this invention, is substantially higher than the activity of FCC catalysts prepared with zeolites non pre-treated or pre-treated according to any other process. One employed both methods cited above to characterize the effect observed in the present invention. With this, one obtained a linear correlation between the n-propylamine TPD and the n-hexane cracking rate, as it shows FIG. 1.

### SUMMARY OF THE INVENTION

The invention comprises a process which combines the mild calcination and the phosphorous deposition in order to infer to zeolites with high silica-alumina ratio (SAR), typically ZSM-5 type zeolites, higher hydrothermal stability and better selectivity to LPG and to light olefins yields, in the FCC process. After being submitted to said process (after vapor deactivation at severe conditions), 10 high SAR zeolites show enhanced acidity and higher catalytic activity than start zeolites or high SAR zeolites submitted to any other process.

### DESCRIPTION OF THE DRAWING

FIG. 1 displays the graphic of the linear correlation obtained between the n-hexane cracking rate at 500° C., after 15 minutes of reaction, and the amount of ammonia molecules released in the TPD with n-propylamine of the sample under investigation.

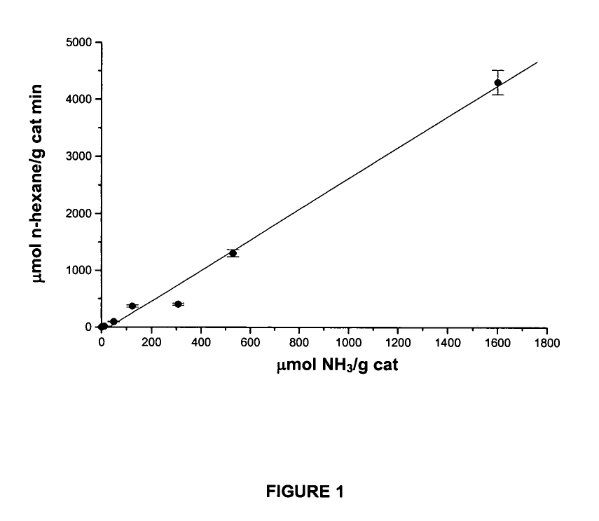

### DETAILED DESCRIPTION OF THE INVENTION

The present invention comprises a process to obtain high silica-alumina ratio (SAR) zeolites which show more resistant to the hydrothermal deactivation and better performance in the Fluid Catalytic Cracking (FCC) process of simple hydrocarbons than the zeolites produced nowadays by state-of-technique processes, as one can verified in the examples below. The process comprises the following steps: a) to obtain a zeolite with silica-alumina ratio higher than or equal to 10, with sodium content lower than 1% w/w, preferably lower than 0.2% w/w and more preferably lower than 0.05% w/w; b) to submit the zeolite to a thermal treatment in the range 350° C.-550° C., more preferably in the range 400° C.-500° C., in the presence of water vapor with water content 100% w/w or lower, depending on the temperature and run time; c) to carry out phosphorous deposition on the zeolite followed by drying, aiming at a phosphorous content in relation to the zeolite weight within the range 1%-10% w/w (referred as P₂O₅), more preferably within the range 2%-7% w/w zeolite.

The preferred zeolite is the ZSM-5 (MFI) but it can be used any zeolite with high SAR, for instance the zeolites ZSM-11, ZSM-12, ZSM-21 and mordenite.

In order to obtain a proper pre-calcination one must employ the mild calcination conditions suggested in the Haag and co-workers' work mentioned hereinbefore. Too severe conditions bring about the zeolite deactivation, while too mild conditions do not activate the zeolite. One zeolite resulting from mild calcination with vapor in proper conditions shows low dealumination level, that is, about 85% of amount of aluminum from the zeolite crystalline framework remains in the crystalline framework after the pre-treatment. Furthermore, the zeolite calcined with vapor shows higher acidity than the start zeolite.

### EXAMPLES

### Example 1

### zeolite ZSM-5 (SAR=40) stabilization via state-of-technique method.

One proceed the stabilization of one ZSM-5 zeolite with SAR=40, hereafter referred as Z1, through the method taught by the European Publication EP 116775. One mixed water to 10 g of Z1 samples, respectively, to prepare suspensions. Afterwards, one added to the suspensions different amounts of phosphoric acid. One dried the samples in an oven at 120° C., during 8 hours and, finally, one calcined at 500° C. by 1 hour. In order to compare the zeolite active sites stability, one submitted each sample to deactivation at 800° C., during 5 hours, with 100% of water vapor. One determined the acidity of the deactivated samples by n-propylamine TPD and n-hexane cracking methods. Table 1 summarizes the results obtained.

TABLE I
Stabilization via state-of-technique method - deactivated samples

| | Sample | | | | | |
|---|---|---|---|---|---|---|
| | 1 | 2 | 3 | 4 | 5 | 6 |
| P₂O₅ (%) | 0.0 | 1.2 | 2.3 | 5.0 | 7.0 | 10 |
| n-C₆ cracked (μmol/g Z min) | — | — | 160 | 297 | — | — |
| Acidic sites (TPD, μmol/g Z) | 14 | 65 | 83 | 92 | 74 | 27 |

Evidently, there is a larger amount of acidic sites in the phosphorous containing samples than in the samples without phosphorous. Even varying the P₂O₅ content, the sample which showed the highest acidity after deactivation (92 μmol/g Z) did not show improvement of the n-hexane cracking activity (297, μmol/g Z min).

### Example 2

### ZSM-5 (SAR=40) stabilization via method of the present invention.

One submitted one sample of the same zeolite Z1 used in Example 1 to mild calcination in a tubular oven. One held an air stream through the oven varying the water vapor content, the calcination temperatures and the calcination times. Afterwards, one contacted each sample with a solution of ammonium mono-phosphate at 80° C. during 4 hours. One dried the samples in an oven at 120° C. and, finally, one calcined at 500° C. by one hour. In order to compare the zeolite active sites stability, one submitted each sample to deactivation at 800° C., during 5 hours, with 100% of water vapor. Table 2 summarizes the results obtained. Compared to the best one stabilization showed in Table 1, the samples stabilized according to the conditions introduced by the present invention showed increases of n-hexane cracking activity higher than 100%.

TABLE II
Stabilization via present invention method - deactivated samples

| | | Sample | | |
|---|---|---|---|---|
| | | 7 | 8 | 9 |
| Calcination | Temperature (° C.) | 540 | 400 | 450 |
| conditions | Time (hours) | 3 | 1 | 1 |
| | pH₂O (kPa) | 20 | 101 | 101 |

| | | | |
|---|---|---|---|
| P₂O₅ (%) | 2.3 | 2.3 | 2.3 |
| n-C₆ cracked (μmol/g Z Min) | 570 | 895 | 665 |

### Example 3

### zeolite ZSM-5 (SAR=40) stabilization out of the conditions recommended by the present invention.

One submitted samples of the same zeolite Z1 used in Examples 1 and 2 to more severe calcinations. Table 3 displays a comparison between the n-hexane cracking activities of these calcined samples and one reference sample not calcined (sample a). One can verify the samples calcined in the conditions recommended by the present invention (x, y e z) resulted increase of n-hexane cracking activity. On the contrary, the samples calcined out of the recommended conditions (a, b e c) did not show activity increase. After the calcination, one accomplished the same ammonium mono-phosphate deposition described in Example 2 in each one of the calcined samples. Table 4 summarizes the results obtained with samples deactivated at 800° C., during 5 hours, with 100% of water vapor. The ratios between the samples activities and the reference activity refer to the n-hexane cracking at 500° C. The activities achieved were lower than the obtained in Example 2.

TABLE III
Samples calcined in and out of the conditions recommended by the invention

| | | Samples | | | | | |
|---|---|---|---|---|---|---|---|
| | | a | b | c | x | y | z |
| Calcination | Invention | no | | | yes | | |
| conditions | Temperature (° C.) | Ref. | 540 | 350 | 540 | 400 | 450 |
| | Time (hours) | Ref. | 1 | 1 | 3 | 1 | 1 |
| | pH₂O (kPa) | Ref. | 101 | 101 | 20 | 101 | 101 |

| | | | | | | |
|---|---|---|---|---|---|---|
| Activity (Sample/Ref.) | 1 | 0.33 | 0.64 | 1.65 | 1.24 | 1.68 |

TABLE IV
Stabilization via non optimized method - deactivated samples

| | | Sample | | |
|---|---|---|---|---|
| | | 10 | 11 | 12 |
| Calcination | Temperature (° C.) | 540 | 350 | — |
| conditions | Time (hours) | 1 | 3 | — |
| | pH₂O (kPa) | 101 | 101 | — |

| | | | |
|---|---|---|---|
| P₂O₅ (%) | 2.3 | 2.3 | 2.3 |
| n-C₆ cracked (μmol/g Z min) | 250 | 380 | 155 |

### Example 4

### zeolite ZSM-5 (SAR=30) stabilization via state-of-technique method.

One proceed the stabilization of one ZSM-5 zeolite with SAR=30, hereafter referred as Z2, through the method taught by the European Publication EP 116775. One mixed water to 10 g of Z2 samples, respectively, to prepare Z2 suspensions. Afterwards, one added to the Z2 suspensions different amounts of phosphoric acid. One dried the suspensions in an oven at 120° C., during 8 hours and, finally, one calcined at 500° C. by 1 hour. In order to compare the zeolite active sites stability, one submitted each sample to deactivation at 800° C., during 5 hours, with 100% of water vapor. One determined the acidity of the deactivated samples by n-propylamine TPD and n-hexane cracking methods. Table 5 summarizes the results obtained.

TABLE V

| | Sample | | | | |
|---|---|---|---|---|---|
| | 13 | 14 | 15 | 16 | 17 |
| P₂O₅ (%) | 0.0 | 1.0 | 2.0 | 5.0 | 8.0 |
| n-C₆ cracked (μmol/g Z min) | — | — | — | 230 | — |
| Acidic sites (TPD, μmol/g Z) | 25 | 29 | 36 | 76 | 62 |

Evidently, there is a larger amount of acidic sites in the phosphorous containing samples than in the samples without phosphorous. Even varying the P₂O₅ content, the sample which showed the highest acidity after deactivation (76 μmol/g Z) did not show improvement of the n-hexane cracking activity (230μmol/g Z min).

### Example 5

### ZSM-5 (SAR=30) stabilization via method of the present invention.

One submitted one sample of the same zeolite Z2 used in Example 4 to mild calcination in a tubular oven, as described in Example 2. After the calcination, one contacted each sample with a solution of ammonium mono-phosphate at 80° C., during 4 hours. One dried the samples in an oven at 120° C. and, finally, one calcined at 500° C. by one hour. In order to compare the zeolite active sites stability, one submitted each sample to deactivation at 800° C., during 5 hours, with 100% of water vapor. Table 6 summarizes the results obtained.

TABLE VI
Stabilization via present invention method - deactivated samples

| | | Sample | | |
|---|---|---|---|---|
| | | 18 | 19 | 20 |
| Calcination | Temperature | 540 | 540 | 540 |
| conditions | Time (hours) | 3 | 3 | 3 |
| | pH₂O (kPa) | 20 | 30 | 30 |

| | | | |
|---|---|---|---|
| P₂O₅ (%) | 2.3 | 2.3 | 4.6 |
| n-C₆ cracked (μmol/g Z Min) | 290 | 360 | 380 |

Compared to the best one stabilization showed in Table 4, the samples stabilized according to the conditions introduced by the present invention showed increases of n-hexane cracking activity higher than 100%.

### Example 6

### zeolite ZSM-5 (SAR=30) stabilization out of the conditions recommended by the present invention.

One submitted samples of the same zeolite Z2 used in Examples 4 and 5 to more severe calcinations. After the calcination one deposited an amount of ammonium mono-phosphate through the same procedure described in Example 5. Table 7 summarizes the results obtained with samples deactivated at 800° C., during 5 hours, with 100% of water vapor. The ratios between the samples activities and the reference activity referred to the n-hexane cracking at 500° C. The activities achieved were lower than the obtained in Example 5.

TABLE VII
Stabilization via non optimized method - deactivated samples

| | | Sample | | | |
|---|---|---|---|---|---|
| | | 21 | 22 | 23 | 24 |
| Calcination | Temperature (° C.) | 500 | 540 | 540 | 540 |
| conditions | Time (hours) | 3 | 2 | 3 | 3 |
| | pH₂O (kPa) | 10 | 10 | 101 | 101 |

| | | | | |
|---|---|---|---|---|
| P₂O₅ (%) | 2.3 | 2.3 | 2.3 | 4.6 |
| n-C₆ cracked (μmol/g Z min) | 230 | 240 | 180 | 190 |

### EXAMPLE 7

### comparison between the catalytic performances of the ZSM-5 zeolites stabilized via process taught by the present invention and via state-of-technique process, through the embedding of such zeolites in the FCC catalyst and subsequent catalytic test accomplished with real feedstock.

One calcined a zeolite with SAR=28, hereafter referred as Z3, in a tubular oven at 425° C. and with 100% of water vapor during 1 hour. This pre-calcined zeolite showed n-hexane cracking activity 1.6 fold higher than the starting zeolite Z3. After calcination one deposited 2.3% of P₂O₅ w/w on the zeolite, hereafter referred as Z-S, according to the procedure described previously in Example 2. As reference for the catalytic activity tests one stabilized a sample of Z3 via state-of-technique process, as described in Example 1, and, afterwards, one treated it with a proper amount of P₂O₅ in order to achieving maximum catalytic performance when embedded to a typical FCC catalyst formulation. This zeolite used as reference hereafter is referred as Z-R. Then, one prepared five FCC catalysts employing the same standard formulation, respectively, as displayed in Table 8. Afterwards, one submitted catalysts samples to the same deactivation of the previous examples, that is, 100% of water vapor, at 800° C., during 5 hours. One verified the textural properties of the samples were pretty seemed, not only before but also after deactivation. If ratified both the validation of the samples preparation and the catalytic activity comparison (Table 9). One accomplished the comparison of catalytic activities of deactivated samples after testing them in an ACE type unit operating with feedstock typically processed in Brazilian refineries.

TABLE VIII

| | | Active | | | | |
|---|---|---|---|---|---|---|
| | | Matrix | Silica | P-ZSM-5 | ZSM-5 | Kaolin |
| Code | REY (%) | (%) | (%) | type | (%) | (%) |
| Cat-1 | 45 | 10 | 24 | — | — | balance |
| Cat-2 | 45 | 10 | 24 | Z-R | 1 | balance |
| Cat-3 | 45 | 10 | 24 | Z-R | 3 | balance |
| Cat-4 | 45 | 10 | 24 | Z-S | 1 | balance |
| Cat-5 | 45 | 10 | 24 | Z-S | 3 | balance |

TABLE IX

| | Fresh | | | Deactivated | | |
|---|---|---|---|---|---|---|
| Catalyst | MiPV | SA ₑₓₜₑᵣₙₐₗ | SA _{BET} | MiPV | SA ₑₓₜₑᵣₙₐₗ | SA _{BET} |
| Code | (cc/g) | (m²/g) | (m²/g) | (cc/g) | (m²/g) | (m²/g) |
| Cat-1 | 0.126 | 82.1 | 354 | 0.059 | 29.3 | 155 |
| Cat-2 | 0.126 | 75.9 | 346 | 0.069 | 31.6 | 179 |
| Cat-3 | 0.128 | 71.3 | 347 | 0.070 | 33.1 | 182 |
| Cat-4 | 0.129 | 72.4 | 351 | 0.071 | 33.6 | 179 |
| Cat-5 | 0.130 | 76.7 | 358 | 0.072 | 36.3 | 189 |

Table 10 displays the results achieved in these activity tests. All samples achieved equivalent conversions, similar to the conversion of base catalyst Cat-1, for a catalyst to oil ratio catloil=4.5. As expected, the catalysts containing 1% and 3% of Z-R, Cat-2 and Cat-3 respectively, showed better yields of value-added products (LPG and propene) than the reference catalyst Cat-1. The performance of the catalysts which contained the zeolite prepared and stabilized by the process of the present invention, Cat-4 and Cat-5, showed yields of value-added products even higher than the catalysts which contained Z-R. One notices the Cat4 propene yield was higher than the Cat-2 was (both containing 1% of ZSM-5). Likewise, Cat-5 propene yield was higher than the Cat-3 (both containing 3% of ZSM-5). One observed the same behavior for the improvement of LPG selectivity. The LPG yield of Cat-4 was higher than Cat-2 (both containing 1% of ZSM-5). The LPG yield of Cat-5 was higher than Cat-3 (both containing 3% of ZSM-5).

TABLE X

| | Catalyst | | | | |
|---|---|---|---|---|---|
| | Cat-1 | Cat-2 | Cat-3 | Cat-4 | Cat-5 |
| Content (%) and Type of selective | — | 1Z-R | 3Z-R | 1Z-S | 3Z-S |
| zeolite | | | | | |
| Conversion at cat/oil = 4.5 (%) | 67.3 | 68.4 | 65.7 | 68.5 | 68.9 |
| Yields at conversion = 68% (%) | | | | | |
| Propeno | 4.2 | 4.4 | 4.9 | 4.6 | 5.5 |
| LPG | 15.3 | 15.8 | 17.0 | 16.5 | 18.5 |
| Gasoline | 44.7 | 44.7 | 43.4 | 44.3 | 42.2 |

The better performance of the catalysts Cat-4 and Cat-5, compared to the catalysts Cat-2 and Cat-3, respectively, confirmed the zeolite Z-S is more resistant to the hydrothermal deactivation than the zeolite Z-R. Most of the acidic sites preserved in Z-S, compared to Z-R, resulted from an increase of the reacting molecules cracking of the gasoline range to form light olefins which are economically more profitable.

1. Process to obtain high silica-alumina ratio zeolite, more resistant to the hydrothermal deactivation, characterized by the following steps: a) obtention of a low Na₂O content zeolite, less than 1% w/w, preferably less than 0.2% w/w and more preferably less than 0.05% w/w; b) to treat said zeolite at a temperature within the range between 350° C. to 550° C., more preferably between 400° C. and 500° C., in the presence of water vapor, with water content in the vapor 100% or less depending on the temperature and time applied; c) to deposit a phosphorous source in said zeolite followed by drying, being the phosphorous content deposited as P₂O₅ between 1% and 10% w/w in relation to the weight of the zeolite, more preferably between 2% and 7% w/w in relation to the weight of the zeolite.

2. Process according to claim 1, characterized by the high silica-alumina zeolite is a MFI type zeolite.

3. Process according to claim 1, characterized by the zeolite has Na₂O content lower than 1% w/w, preferably lower than 0.2% w/w and more preferably lower than 0.05% w/w in relation to the weight of the zeolite.

4. Process according to claim 1, characterized by the zeolite is calcined in the presence of water vapor at a temperature within the range between 350° C. and 550° C., more preferably between 400° C. and 500° C.

5. Process according to claim 1, characterized by the zeolite exhibits after the calcination higher acidity than the starting zeolite.

6. Process according to claim 1, characterized by one deposits a source of phosphorous on the zeolite and, afterwards, one dries the zeolite. The phosphorous content as P₂O₅, must be within the range between 1% and 10% w/w, in relation to the weight of the zeolite, and more preferably between 2% and 7% w/w in relation to the weight of the zeolite.

7. Process for phosphorous deposition on ZSM-5 type zeolite useful either as catalysts component or as additives employed in fluid catalytic cracking processes.

8. Process to obtain active zeolites which contribute to the fluid catalytic cracking process by improving the selectivity for LPG and light olefins as propene and iso-butene.
